(19) United States
(12) Patent Application Publication
(10) Pub. No.: US 2022/0078026 A1
(43) Pub. Date: Mar. 10, 2022

(54) VERIFICATIONS OF WORKLOAD SIGNATURES

(71) Applicant: Hewlett-Packard Development Company, L.P., Spring, TX (US)

(72) Inventors: Thomas Flynn, Spring, TX (US); Srivatsan Mani, Spring, TX (US); Trey Elliott, Spring, TX (US)

(73) Assignee: Hewlett-Packard Development Company, L.P., Spring, TX (US)

(21) Appl. No.: 17/419,248

(22) PCT Filed: Apr. 30, 2019
(86) PCT No.: PCT/US2019/030017

§ 371 Date: Jun. 28, 2021

(51) Int. Cl. H04L 9/32; G06F 21/44; H04L 9/08; G06F 9/30; G06F 21/57; G06F 9/48

(52) U.S. Cl. CPC H04L 9/3247; G06F 21/44; H04L 9/0891; G06F 2221/033; G06F 21/575; G06F 21/572; G06F 9/4881; G06F 9/30

(57) ABSTRACT

A network interface connector may receive a workload via a network. A security chip may verify a signature of the workload based on a public-private key pair, the private key corresponding to the security chip. A processor may execute the workload in response to the verification of the signature.

### BACKGROUND

Distributed computing may allow a central data server to break a computing task into multiple workloads for execution by a distributed set of endpoints. The central data server may base the workloads for an individual endpoint based on the resources available to the endpoint.

### BRIEF DESCRIPTION OF THE DRAWINGS

Various examples will be described below referring to the following figures:

FIG. 1A shows an apparatus comprising a processor, a network interface connector, and a security chip in accordance with various examples;

FIG. 1B shows an apparatus comprising a processor, a network interface connector, a computer-readable medium, and a security chip in accordance with various examples;

FIG. 2 shows a computer-based medium with machine-readable instructions to receive a workload, verify the workload, and execute the workload in accordance with various examples; and

FIG. 3 shows a method to assemble a workload, sign the workload, and transmit the signed workload via a network in accordance with various examples.

### DETAILED DESCRIPTION

Execution of distributed workloads may pose a security risk to the endpoints executing the workloads. Malicious code may be present in the workload or a workload may be presented for execution from a source other than an authorized central data server.

The central data server may digitally sign workloads using a public and private key pair. The endpoint may verify the signature of the workload to know the workload has been provided by an authorized central data server. The cryptographic keys used by the authorized central data server may be specific to the endpoint being provided with the workload.

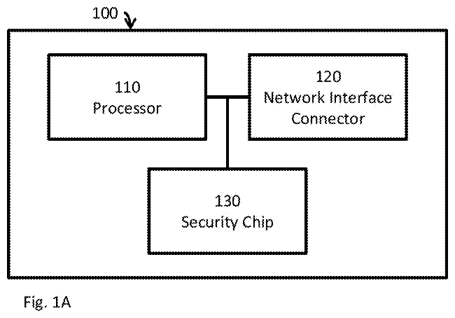

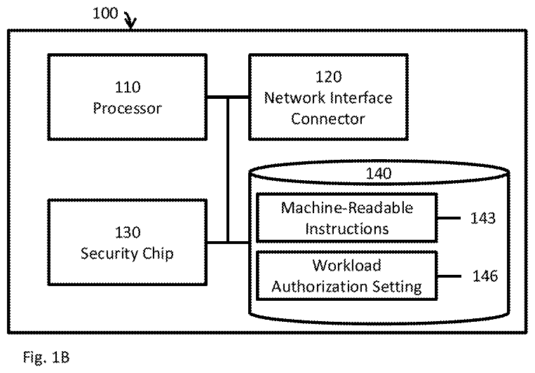

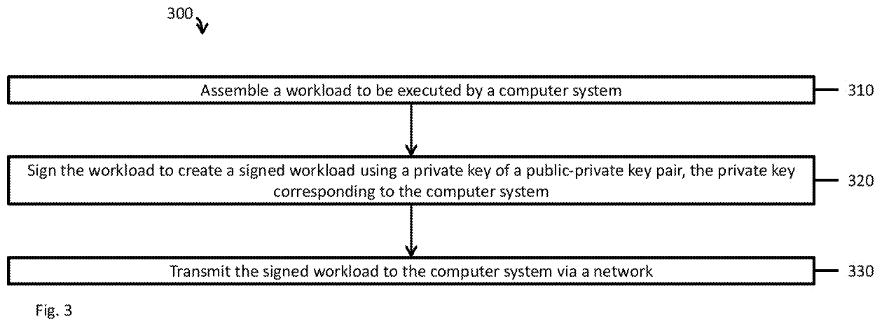

FIG. 1A shows an apparatus 100 comprising a processor 110, a network interface connector 120, and a security chip 130 in accordance with various examples. The processor 110, network interface connector 120, and security chip 130 may be coupled together, such as via a bus. The apparatus 100 may serve as an endpoint in a distributed computing network. The apparatus 100 may be a computing device, such as a laptop computer, desktop computer, server, tablet, or mobile phone. The processor 110 may comprise a microprocessor, a microcomputer, a microcontroller, a field programmable gate array (FPGA), or discrete logic. The processor 110 may execute machine-readable instructions that implement the methods described herein, such as the method described in connection with FIG. 3. The network interface connector 120 may communicate over a network. The network interface connector 120 may include a wired connection, such as Ethernet or universal serial bus (USB), or a wireless connection, such as WiFi or Bluetooth. The network interface connector 120 may receive a workload for execution or processing by the apparatus 100. The security chip 130 may be an electronic chip or collection of discrete logic. The security chip 130 may include memory to store cryptographic keys. The security chip 130 may verify that the workload comes from a trusted source and is meant for execution or processing by the apparatus 100. In response to verification of the workload by the security chip 130, the processor 110 may execute or process the workload.

In various examples, the security chip 130 may include a trusted platform module. The workload may be signed by the private key of a public-private key pair. The security chip 130 may use the public key to verify the signature of the workload. The signature of the workload may be an encryption of the workload using the private key, an encryption of a hash of the workload using the private key, or other appropriate signature to allow the security chip 130 to verify the workload has not been modified and the workload was provided by the trusted source.

In various examples, while the central data server may sign the workload with the private key, the private key may actually belong to or correspond to the apparatus 100. During manufacture, the private key may be prepared for the apparatus and stored by the central data server. The public key and possibly the private key may be stored in the security chip 130. The central data server may use the private key to sign workloads or other communications with the apparatus 100. When communicating with other endpoints, the central data server may use a different private key corresponding to the other endpoints or the security chips in those endpoints.

If the security chip 130 verifies the signature of the workload, the processor 110 may execute or process the workload. The workload may include machine-readable instructions for execution by the processor 110. The workload may include data for manipulation by the processor 110, based on the machine-readable instructions in the workload or based on existing machine-readable instructions stored in the apparatus 100. If the security chip 130 cannot verify the signature of the workload, the workload may not be executed or processed. The workload may have come from a source other than the authorized central data server, or the workload may be from the authorized central data server but signed using a private key for a different endpoint. The other endpoint should be receiving and handling the workload, rather than the apparatus 100.

In addition to verifying the signature of the workload, a workload authorization setting may be checked before executing or handling the workload. The workload authorization setting may be settable by a user of the apparatus 100 to control whether the apparatus 100 is accepting workloads for execution or handling. In various examples, the workload authorization setting may be checked before verifying the signature of a workload. When the workload authorization setting specifies that workloads are not being accepted, the apparatus 100 may send a message to the authorized central data server rejecting the workload. To prevent communication of workloads over the network interface connector 120 when workloads are not being accepted, the apparatus 100 may send such a message to the authorized central data server when the workload authorization setting is modified.

In various examples, the public-private key pair may correspond to multiple endpoints. The size and groupings of these endpoints may be arbitrary. A set of endpoints owned and operated by one business may use the same public-private key pair. Any workload sent to one of these endpoints may be signed using the same private key. The workloads may still be sent to specific endpoints for processing.

In various examples, the security chip 130 may be used to perform verification of the operating system of the apparatus 100 or applications executing on the processor 110. During startup, the security chip 130 may perform a secure boot, verifying that the operating system has not been modified from a known good state. Modification of the operating system may indicate the presence of a disruptive application, such as a virus or trojan. The security chip 130 may also verify applications to execute on the processor 110. The application that handles the workloads may be one such application verified by the security chip 130. Verification of the operating system, application, and workload may provide additional protection against execution of malicious code on the apparatus 100. The operating system and application may be stored in a computer-readable medium coupled to the processor. The computer-readable medium may include a hard drive, solid state drive (SSD), flash memory, electrically erasable programmable read-only memory (EEPROM), or random access memory (RAM).

In various examples, the security chip 130 may update the public-private key pair used to verify the workloads. The new public or private key may be received via the network interface connector 120 or via a removable medium, such as a USB memory stick. The security chip 130 may include provisions to verify that the update of the public-private key is authorized so as to prevent use of the update process to provide a public-private key pair from an unauthorized central data server.

FIG. 1B shows an apparatus 100 comprising a processor 110, a network interface connector 120, a computer-readable medium 140, and a security chip 130 in accordance with various examples. The computer-readable medium 140 includes machine-readable instructions 143 and a workload authorization setting 146.

In various examples, the computer-readable medium 140 may include memory that is part of the security chip 130 and main memory or long-term memory of the apparatus 100, such as RAM or a SSD. The machine-readable instructions 143 may be stored in the long-term memory. The workload authorization setting 146 may be stored in the long-term memory or in memory that is part of the security chip 130. The workload authorization setting 146 may be stored in a registry of the apparatus 100.

In various examples, a user may modify the workload authorization setting 146. A user may supply a password when modifying the workload authorization setting 146. Modification of the workload authorization setting 146 may be limited to certain users or certain groups of users, such as by an administrator. The workload authorization setting 146 may specify that workloads are authorized from certain central data servers but not from others, regardless of whether the workloads are properly signed. The workload authorization setting 146 may restrict handling of workloads to workloads that use or do not use certain resources of the apparatus 100. The workload authorization setting 146 may include a timer, where the authorization to handle workloads ends upon expiration of the timer, or where the restriction against handling workloads ends upon expiration of the timer. The workload authorization setting 146 may be based on a calendar or clock. For example, the workload authorization setting 146 may allow handling of workloads during times when the apparatus is otherwise in off-peak usage, such as the middle of the night or on weekends.

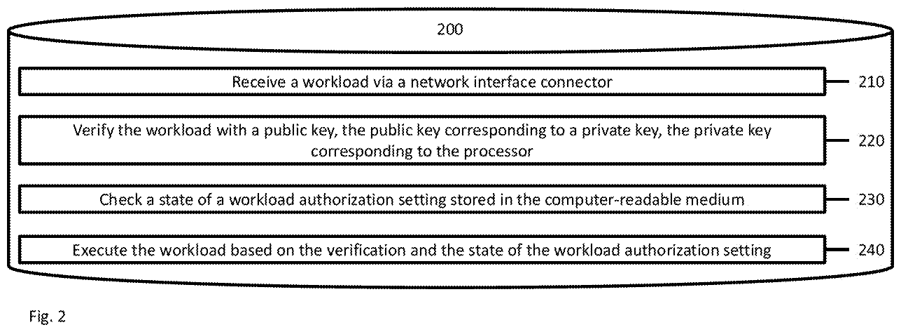

FIG. 2 shows a computer-readable medium 200 with machine-readable instructions 210, 220, 230, 240 to receive a workload, verify the workload, and execute the workload in accordance with various examples. The instructions 210, 220, 230, 240 may be machine-readable instructions for execution by a processor. Execution of instruction 210 may cause the processor to receive a workload via a network interface connector. Execution of instruction 220 may cause the processor to verify the workload with a public key, the public key corresponding to a private key, the private key corresponding to the processor. The public key may be stored in a security chip or a secure memory coupled to the processor. The security chip or secure memory may also store the private key. Execution of instruction 230 may cause the processor to check a state of a workload authorization setting stored in the computer-readable medium. Execution of instruction 240 may cause the processor to execute the workload based on the verification and the state of the workload authorization setting. Execution of the workload may include executing machine-readable instructions in the workload or manipulating data included in the workload.

In various examples, the processor may check a state of the workload authorization setting before handling the workload. If the workload authorization setting indicates that workloads are not authorized, the processor may delete the workload without verifying or executing or otherwise handling the workload. The processor may send a message to the central data server indicating the workload was rejected. The message may include an indication of the reason for rejection.

In various examples, the processor may verify the workload before executing the workload. The verification of the workload by the processor may be in addition to verification of the workload using the public key. The processor may verify that the workload actually contains content that the processor can process.

In various examples, the central data server may encrypt the workload using the private key. Verification of the workload using the public key may include decrypting the workload with the public key.

In various examples, an endpoint may use a first public key to verify a workload is intended for that endpoint and comes from an authorized central data server. The public-private key pair corresponding to that endpoint may be updated to a second public-private key pair, at which point, the endpoint may use the second public key to verify incoming workloads.

FIG. 3 shows a method 300 to assemble a workload, sign the workload, and transmit the signed workload via a network in accordance with various examples. The method 300 includes assembling a workload to be executed by a computer system (310). The method 300 includes signing the workload to create a signed workload using a private key of a public-private key pair, the private key corresponding to the computer system (320). The method 300 includes transmitting the signed workload to the computer system via a network (330). Method 300 may be performed by a central data server to provide workloads to various endpoints. The central data server may store multiple private keys corresponding to different endpoints. Use of the specific endpoint's private key to sign or encrypt the workload may indicate to the endpoints that the workload was provided by an authorized central data server and that the workload is meant for handling by the specific endpoint.

In various examples, when the central data server is to send a second workload to a second endpoint, the central data server may assemble the second workload. The central data server may sign the second workload using a second public-private key pair that corresponds to the second endpoint. The second workload may be transmitted to the second endpoint. On receipt, the second endpoint may use the public key of its public-private key pair to verify that the workload is from the authorized central data server and that the workload is meant for the second endpoint. If the first endpoint were to receive the second workload, the signature would not be verified, as it uses a different public-private key pair. In such circumstances, the first endpoint may not handle the second workload.

In various examples, the central data server may send a third workload to a third endpoint using the public-private key of the first endpoint. The first and third endpoint may share the public-private key pair. The central data server may assemble the third workload. The central data server may sign the third workload using the private key, which corresponds to both the first endpoint and third endpoint. The central data server may transmit the third workload to the third endpoint. If the first endpoint receives the third workload, the signature would be verifiable using the public key, and the first endpoint may handle the third workload. Handling of a workload by multiple endpoints that share a public-private key pair may be desired in some cases. For example, the central data server may want a workload to be handled quickly and provide the workload to multiple endpoints, using the results of the first completed workload. The central data server may use the multiple endpoints for redundancy checking, ensuring that the endpoints agree on the results.

In various examples, an endpoint may register itself with the central data server. The registration may notify the central data server that the endpoint may be used for distributed computing. As part of registration, the endpoint may provide information regarding the resources of the endpoint. The resources may include processing ability, available short-term or long-term memory, or peripheral devices. In assembling workloads, the central data server may match the workload with the resources available to an endpoint. When a match is made, the central data server may assemble a workload specific to the endpoint.

In various examples, the endpoints may be used as part of the distributed computing network when otherwise not in use. The endpoint may communicate with the central data server to indicate when the endpoint is idle and ready to receive workloads. The endpoint may communicate with the central data server to indicate the endpoint will no longer accept workloads due to local activities of the endpoint, such as when a user begins using a computer. The endpoint may communicate with the central data server when the workload authorization setting of the endpoint changes. The central data server may begin sending workloads to the endpoint in response to the indication that the endpoint is ready to receive workloads. The central data server may halt the sending of workloads when the endpoint indicates it is being used locally.

Verification of the signatures of workloads allows the endpoints control over their use as distributed computing devices. Multiple central data servers may exist, such as from different companies providing distributed computing services. Through cryptography, an endpoint may ensure that a workload was provided by an authorized central data server. The endpoint determines whether the central data server is authorized and may still decline to process workloads from an authorized central data server. Workloads from unauthorized central data servers, or even from an authorized central data server but signed using a different endpoint's private key, may not be executed by the endpoint.

In various examples, an endpoint may sign up to be a distributed computing device for multiple central data servers. The central data servers may use the same public-private key pair for communication with the endpoint, as the key pair belongs to the endpoint, or different public-private key pairs may be used for communication with the different central data servers.

In various examples, an endpoint may remove itself from the distributed computing network by removing or disabling its copy of the public-private key pair. This may be performed when retiring a computing device from a fleet of computing devices operated by a company. This may also be done when reconfiguring a fleet of computing devices that use the same public-private key pair for communications with the central data server. Individual computing endpoints may be added or removed by temporarily, or permanently, disabling the key pair in the individual endpoint.

In various examples, the results of handling the workload may be returned to the central data server from the endpoint. The endpoint may use the same public-private key pair to sign or encrypt the response. Additional tracking may be performed by the endpoint or the central data server to provide for billing or payments for use of the endpoint in the distributed computing network.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. An apparatus comprising:
a network interface connector to receive a workload via a network;
a security chip to verify a signature of the workload, the signature based on a private key of a public-private key pair, the private key corresponding to the security chip; and
a processor coupled to the network interface connector and the security chip, the processor to execute the workload in response to the verification of the signature.

2. The apparatus of claim 1 comprising a computer-readable medium coupled to the processor, the computer-readable medium comprising machine-readable instructions, wherein execution of the machine-readable instructions is to cause the processor to execute the workload.

3. The apparatus of claim 2, wherein the security chip is to:
verify an operating system; and
verify an application to execute on the processor, the application comprising the machine-readable instructions.

4. The apparatus of claim 1, wherein the security chip is to update the public-private key pair.

5. The apparatus of claim 1, wherein the workload comprises machine-readable instructions, and the execution of the workload includes execution of the machine-readable instructions in the workload.

6. A non-transitory computer-readable medium to store machine-readable instructions that, when executed by a processor, cause the processor to:
receive a workload via a network interface connector;
verify the workload with a public key, the public key corresponding to a private key, the private key corresponding to the processor;
check a state of a workload authorization setting stored in the computer-readable medium; and
execute the workload based on the verification and the state of the workload authorization setting.

7. The computer-readable medium of claim 6, wherein the processor includes a trusted platform module to verify the workload using the public key.

8. The computer-readable medium of claim 6, wherein the verification of the workload includes decryption of the workload with the public key.

9. The computer-readable medium of claim 6, wherein the machine-readable instructions, when executed by the processor, cause the processor to perform a secure boot, including to:
verify an operating system to execute on the processor; and
verify an application to execute on the processor, the application to perform the execution of the workload.

10. The computer-readable medium of claim 6, wherein the verification of the workload includes verification with a second public key, the second public key corresponding to the processor.

11. A method comprising:
assembling a workload to be executed by a computer system;
signing the workload to create a signed workload using a private key of a public-private key pair, the private key corresponding to the computer system; and
transmitting the signed workload to the computer system via a network.

12. The method of claim 11 comprising:
assembling a second workload to be executed by a second computer system;
signing the second workload to create a second signed workload using a second private key of a second public-private key pair, the second private key corresponding to the second computer system; and
transmitting the second signed workload to the second computer system via the network.

13. The method of claim 12 comprising:
assembling a third workload to be executed by a third computer system;
signing the third workload to create a third signed workload using the private key, the private key corresponding to the third computer system; and
transmitting the third signed workload to the third computer system via the network.

14. The method of claim 11 comprising receiving a workload request from the computer system, and transmitting the signed workload to the computer system in response to the workload request.

15. The method of claim 11 comprising sending a message to the computer system, the message including a replacement public-private key pair.
